(19) United States
(12) Patent Application Publication
(10) Pub. No.: US 2019/0152348 A1
(43) Pub. Date: May 23, 2019

(54) SUPPORT APPARATUS

(71) Applicant: AISIN SEIKI KABUSHIKI KAISHA, Kariya-shi (JP)

(72) Inventor: Naoya ISHIDA, Chiryu-shi (JP)

(73) Assignee: AISIN SEIKI KABUSHIKI KAISHA, Kariya-shi (JP)

(21) Appl. No.: 16/180,504

(22) Filed: Nov. 5, 2018

(30) Foreign Application Priority Data
Nov. 22, 2017 (JP) 2017-224817

(51) Int. Cl. B60N 2/02

(52) U.S. Cl. CPC B60N 2/0244; B60N 2/914; B60N 2002/026

(57) ABSTRACT

A support apparatus that supports an occupant sitting on a seat of a vehicle includes: a press device configured to support the occupant with a pressing force; and a control device configured to control the press device, in which the control device determines a support amount corresponding to a magnitude of the pressing force that presses the occupant, controls the press device so as to output the pressing force corresponding to the support amount, and changes a level of the support amount based on an operation instruction from an operation unit that is operated by the occupant.

### CROSS REFERENCE TO RELATED APPLICATIONS

This application is based on and claims priority under 35 U.S.C. § 119 to Japanese Patent Application 2017-224817, filed on Nov. 22, 2017, the entire contents of which are incorporated herein by reference.

### TECHNICAL FIELD

This disclosure relates to a support apparatus which supports an occupant of a vehicle.

### BACKGROUND DISCUSSION

As a support apparatus mounted in a vehicle, a technique described in JP2017-065343A (Reference 1) is known.

The support apparatus described in Reference 1 detects the posture of an occupant. Then, the support apparatus calculates the degree of cooperation between the posture and the behavior of the vehicle, and gives the occupant support corresponding to the degree of cooperation.

However, what posture the occupant will take or how much support is needed with respect to the behavior of the vehicle depends largely on the preference of the occupant or the physique of the occupant. In this respect, the support apparatus in the related art has room for improvement. Thus, a need exists for a support apparatus which is not susceptible to the drawback mentioned above.

### SUMMARY

A support apparatus according to an aspect of this disclosure supports an occupant sitting on a seat of a vehicle, and includes: a press device configured to support the occupant with a pressing force; and a control device configured to control the press device, in which the control device determines a support amount corresponding to a magnitude of the pressing force that presses the occupant, controls the press device so as to output the pressing force corresponding to the support amount, and changes a level of the support amount based on an operation instruction from an operation unit that is operated by the occupant.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a seat having a support apparatus;

FIG. 2 is a block diagram of the support apparatus;

FIG. 3 is a schematic view of a press device;

FIG. 4 is a graph used when a predicted acceleration increases;

FIG. 5 is a graph used when a predicted acceleration decreases;

FIG. 6 is a view for explaining a relationship between a support amount and the state of the press device;

FIG. 7 is a view for explaining a method of determining the support amount;

FIG. 8 is a flowchart of a support control process;

FIG. 9 is a flowchart of a support continuation process; and

FIG. 10 is a timing chart illustrating a relationship between a predicted acceleration and the support amount.

### DETAILED DESCRIPTION

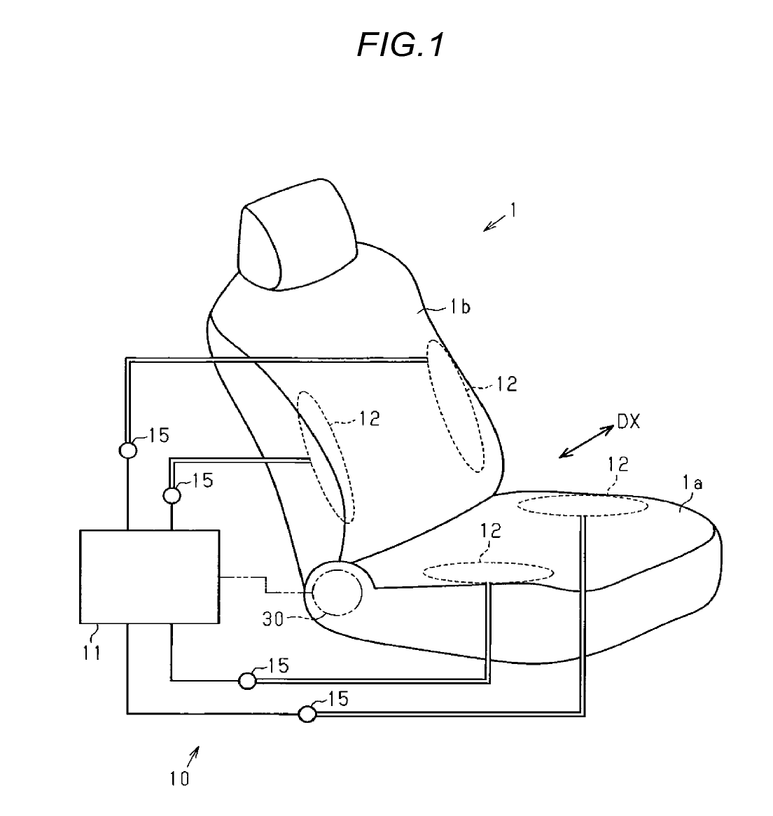

A support apparatus will be described with reference to FIGS. 1 to 10.

In the following description, “vehicle width direction DX” in a seat 1 indicates a direction along the vehicle width direction of a vehicle.

The support apparatus 10 is mounted in the vehicle. The support apparatus 10 supports an occupant sitting on the seat 1 of the vehicle. For example, the support apparatus 10 is provided in the driver's seat 1.

As illustrated in FIG. 1, an air bag 13 (see below) of the support apparatus 10 is disposed in the seat 1.

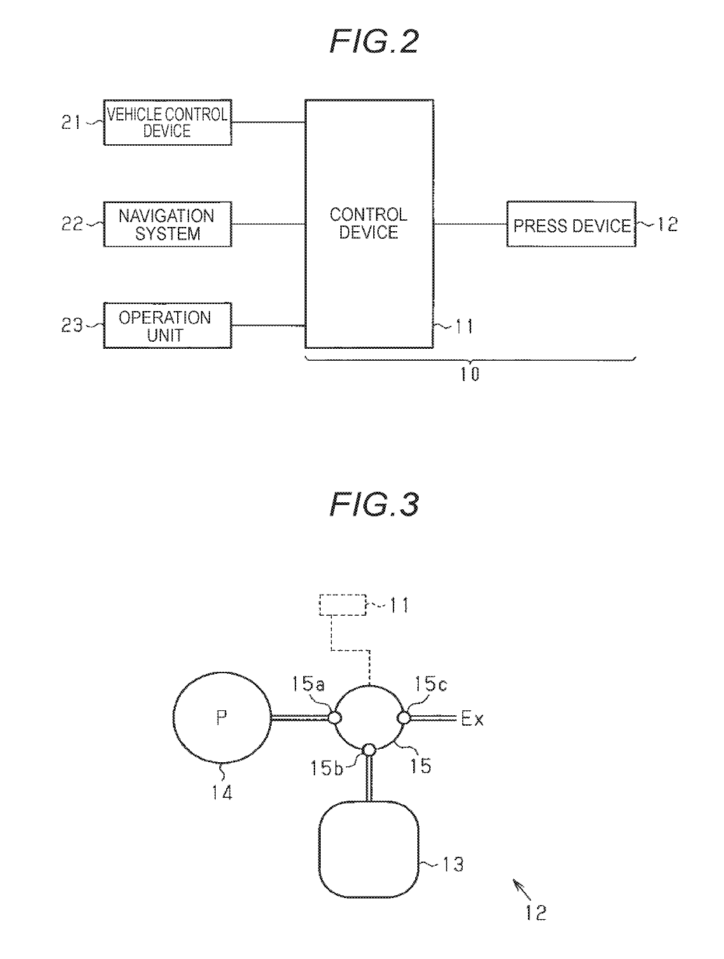

As illustrated in FIG. 2, the support apparatus 10 includes a control device 11 and a press device 12 which operates in response to an instruction from the control device 11.

The press device 12 supports the occupant sitting on the seat 1 with a pressing force. The press device 12 supports the occupant from the lateral side thereof so as to prevent the posture of the occupant from deviating from the basic posture. The press device 12 flexibly supports the lateral side of the body according to a situation in which the posture of the occupant collapses from the basic posture. The press device 12 is constituted by, for example, an opening and closing member which is opened and closed by a motor and a support bag which inflates and deflates by the supply and discharge of a gas or a liquid.

An example of the press device 12 will be described with reference to FIG. 3.

The press device 12 includes the air bag 13, a pump 14 which supplies air, and a control valve 15 provided in a flow path which interconnects the pump 14 and the air bag 13. The control valve 15 is controlled by the control device 11. The control valve 15 is configured with, for example, a three-way valve. The control valve 15 includes a first port 15a connected to the pump 14, a second port 15b connected to the air bag 13, and a third port 15c connected to an exhaust port Ex.

The air bag 13 is disposed in the seat 1. The air bag 13 is formed of an elastic member (e.g., rubber). The air bag 13 is disposed in both sides of the seat 1 with the central portion of the seat 1 therebetween in the vehicle width direction DX. For example, a pair of air bags 13 is arranged in a seat cushion 1a with a space therebetween in the vehicle width direction DX. Similarly, a pair of air bags 13 is arranged in a seat back 1b with a space therebetween in the vehicle width direction DX. The respective air bags 13 cooperate with each other, or operate independently of each other. One end of the air bag 13 is fixed. When the pair of air bags 13 in both sides of the seat 1 in the vehicle width direction DX inflate, the walls of the air bags 13 are formed on both sides of the central portion with the central portion of the seat 1 interposed therebetween. Such a pair of air bags 13 presses both lateral sides of the body. When an acceleration is applied to the body in a transverse direction (vehicle width direction DX), tilting of the body is suppressed since the body is supported by the air bags 13. When the air bags 13 deflate, spaces are formed on both lateral sides of the body, which allows the body to freely move.

The control valve 15 is controlled by the control device 11. The control device 11 operates the control valve 15 to supply air to the air bag 13 so as to inflate the air bag 13. The control device 11 operates the control valve 15 to evacuate the air bag 13 so as to deflate the air bag 13.

The magnitude of the pressing force with which the press device 12 supports the body is defined as, for example, the amount of air in the air bag 13. The amount of air to be supplied into the air bag 13 is controlled by the supply time of air. The supply time of air is controlled by the control device 11.

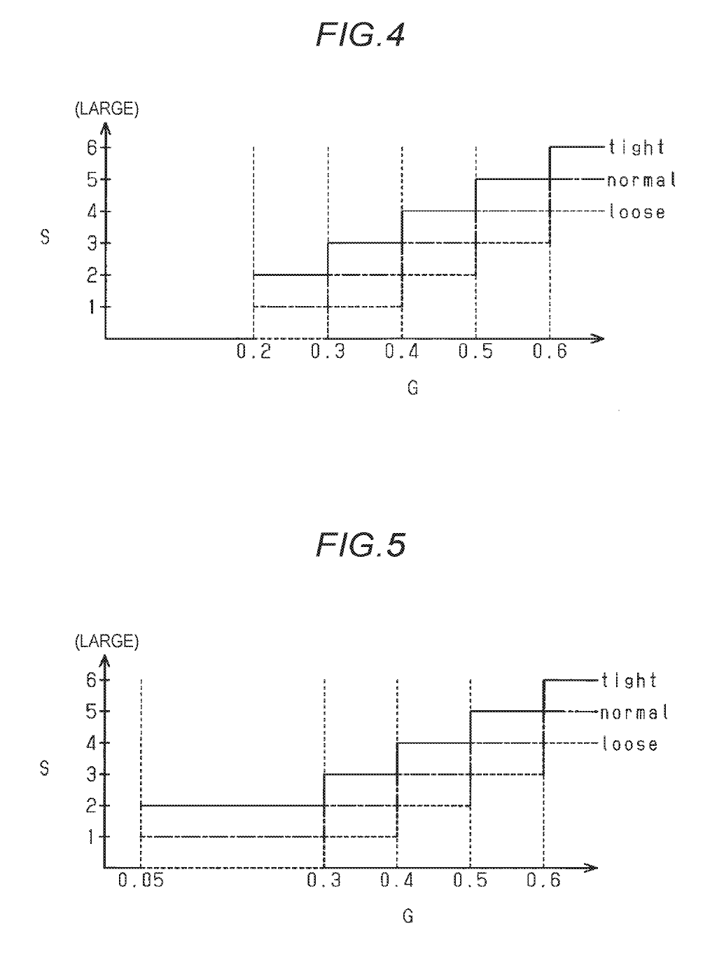

The control device 11 controls the press device 12 so as to output a predetermined pressing force. Specifically, the control device 11 determines a support amount S corresponding to the pressing force of the press device 12. For example, the support amount S is divided into seven magnitudes from “0” to “6” (see FIGS. 4 and 5). The support amount S of “0” is the state of providing no support, and the supply amount of air is “0.” The supply amount of air is set so that the support amount S increases from “1” to “6” in this order. Then, the control device 11 controls the control valve 15 of the press device 12 so that the press device 12 outputs the pressing force corresponding to the support amount S. Specifically, the control device 11 adjusts the amount of air to be supplied to the air bag 13 by controlling the supply time of air from the pump 14 to the air bag 13. In this way, the press device 12 outputs the pressing force corresponding to the support amount S.

For the purpose of determining the support amount S, the control device 11 acquires traveling state information, a vehicle position PM, road information around the vehicle position PM, and the heading direction of the vehicle on a map.

The traveling state information indicates the traveling state of the vehicle. The traveling state information may include, for example, a vehicle speed V and an acceleration. In the present embodiment, the control device 11 acquires the vehicle speed V at a present time. The control device 11 acquires the traveling state information from a vehicle control device 21 via an in-vehicle communication network. The vehicle control device 21 is a device mounted in the vehicle and outputs at least the traveling state information of the vehicle such as, for example, the vehicle speed V and the acceleration of the vehicle.

The road information around the vehicle position PM is information on a road within a predetermined range including the vehicle position PM (position that may be specified by latitude and longitude). The road information around the vehicle position PM may be, for example, the curvature Ri of the road including the vehicle position PM or the inclination angle of the road including the vehicle position PM. The control device 11 acquires these pieces of information, i.e., the vehicle position PM, the road information around the vehicle position PM, and the heading direction of the vehicle on the map from a navigation system 22.

The navigation system 22 outputs at least the vehicle position PM on the map, the road information around the vehicle position PM, and the heading direction of the vehicle on the map. The navigation system 22 may have a function of indicating a route to a destination.

The control device 11 determines the support amount S for the occupant based on a predicted acceleration G (acceleration in the vehicle width direction DX to be applied to the vehicle in the future, see below). For example, the control device 11 determines the support amount S based on the graphs illustrated in FIGS. 4 and 5 in which the predicted acceleration G and the support amount S are associated with each other. The graph illustrated in FIG. 4 (hereinafter, “increasing graph”) is used when the predicted acceleration G increases or when there is no change. The graph illustrated in FIG. 5 (hereinafter, “decreasing graph”) is used when the predicted acceleration G decreases. As illustrated in FIGS. 4 and 5, the support amount S is set to a greater value as the predicted acceleration G is greater. As illustrated in FIG. 4, in the standard level graph (normal in FIG. 4, see below), the support start condition in which the support amount S changes from “0” to “1” is that the predicted acceleration G is equal to or greater than a start reference value (in the present embodiment, “0.2”). As illustrated in FIG. 5, in the standard level graph (normal in FIG. 5, see below), the support stop condition in which the support amount S changes from a predetermined value to “0” is that the predicted acceleration G is less than a stop reference value (in the present embodiment, “0.05”). The stop reference value is less than the start reference value. Therefore, when support is started, support is hardly stopped. The occupant may feel uncomfortable when the state with support and the state without support are repeated. In order to suppress such discomfort, graph setting is performed in this manner so that support is hardly stopped after support is started.

The control device 11 changes the level of the support amount S based on an operation instruction from an operation unit 23 which may be operated by the occupant. The operation unit 23 is a device that selects the level of the support amount S by an operation of the occupant. The operation unit 23 is configured with, for example, a switch, a lever, an operation panel, or a voice recognition device that recognizes an instruction of the occupant.

Specifically, the control device 11 stores multiple graphs of different levels. The “level” indicates the magnitude of the support amount S in the entire graph. For example, as illustrated in FIGS. 4 and 5, the control device 11 stores a tight graph (tight), a standard graph (normal), and a loose graph (loose). In the tight graph, the support amount S is greater than that in the standard graph in the entire range of the predicted acceleration. In the loose graph, the support amount S is less than that of the standard graph in the entire range of the predicted acceleration. When the control device 11 uses the tight graph, the pressing force against the occupant is always higher as compared with a case where the standard graph is used, and the occupant is strongly supported. When the control device 11 uses the loose graph, the pressing force against the occupant is always weakened as compared with a case where the standard graph is used, and the occupant is loosely supported. The occupant may select one of the graphs via the operation unit 23.

The control device 11 outputs a predetermined instruction to the press device 12 so that the press device 12 operates with the support amount S determined using the graph. This instruction is executed based on the support amount S to be applied to the occupant in the future for the following reasons.

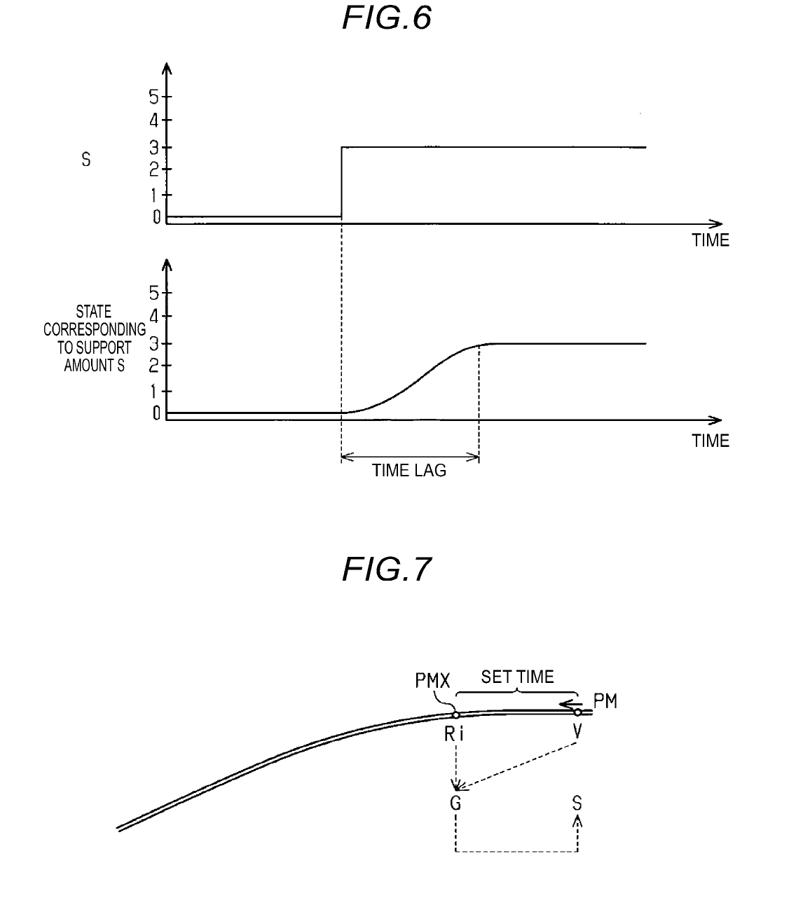

As illustrated in FIG. 6, a predetermined time passes from a time when the control device 11 determines the support amount S and instructs the press device 12 to operate with the support amount S until the press device 12 reaches the state corresponding to the support amount S (e.g., a predetermined size of the air bag 13 corresponding to the support amount S). Such a time is a time lag, and the time lag is longer as the value of the support amount S is greater. In particular, when the pressing force of the press device 12 is formed by the inflation of the air bag 13 as illustrated in the present embodiment, this time lag may not be ignored in order to appropriately support the occupant. That is, when the press device 12 operates with the support amount S determined based on the predicted acceleration G of the vehicle at the present time, the state of the vehicle (e.g., the acceleration that the vehicle receives in the vehicle width direction DX) at the time when the press device 12 reaches the state corresponding to the support amount S may differ from the state of the vehicle at the present time. Therefore, the support that the press device 12 gives to the occupant at a future time is inappropriate for the occupant. For this reason, as described above, the instruction issued by the control device 11 to the press device 12 is executed based on the support amount S to be applied to the occupant after a lapse of a set time from the present time. The set time may be longer than the maximum value of the time lag of the press device 12. The maximum value of the time lag is the time required for the press device 12 to shift from the minimum state of the support amount S to the maximum state of the support amount S. With such a set time, the support of the press device 12 is not delayed with respect to the support amount S to be applied to the occupant.

FIG. 7 is a view for explaining a method of determining the support amount S.

The control device 11 calculates the predicted acceleration G in order to determine the support amount S using the above graph. The predicted acceleration G is a value that corresponds to the acceleration in the vehicle width direction DX to be applied to the vehicle after the lapse of the set time from the present time.

The support amount S output to the press device 12 at the present time is the support amount S to be applied to the occupant in the future. Specifically, the control device 11 calculates the support amount S to be applied to the occupant in the future as a value corresponding to the “acceleration in the vehicle width direction DX to be applied after the lapse of the set time” as illustrated in the above-described graph. The “acceleration in the vehicle width direction DX to be applied after the lapse of the set time” may be calculated based on the curvature Ri of the road at the position where the vehicle reaches after “the lapse of the set time” and the vehicle speed V “after the lapse of the set time.” It is difficult to precisely predict “the position where the vehicle reaches” and the vehicle speed V “after the lapse of the set time.” Thus, it is assumed that the vehicle speed V is constant from the present time to a time after the lapse of the set time. Based on such an assumption, the control device 11 determines the support amount S output to the press device 12 at the present time by the following sequence from (a) to (d).

(a) The control device 11 acquires the vehicle position PM at the present time, road information around the vehicle position PM at the present time, and the heading direction of the vehicle on the map from the navigation system 22.

(b) The control device 11 specifies a vehicle position PMX after the lapse of the set time based on the vehicle position PM at the present time, the heading direction of the vehicle, the vehicle speed V at the present time, and the road information of the road where the vehicle travels.

(c) The control device 11 acquires the curvature Ri at the vehicle position PMX after the lapse of the set time from the navigation system 22. Then, the control device 11 calculates the acceleration at the vehicle position PMX as the predicted acceleration G based on the curvature Ri at the vehicle position PMX and the vehicle speed V. That is, the predicted acceleration G is the acceleration applied to the vehicle in the vehicle width direction DX, and indicates the acceleration at the time after the lapse of the set time from the present time.

(d) The control device 11 compares the predicted acceleration G calculated at the present time with the predicted acceleration G calculated at a time before the present time, and determines whether or not the predicted acceleration G is increasing. Then, when the predicted acceleration G increases or does not change, the control device 11 selects the increasing graph. When the predicted acceleration G is decreasing, the control device 11 selects the decreasing graph. Then, the control device 11 determines the support amount S using the selected graph. The control device 11 controls the press device 12 so as to operate with the support amount S determined in this manner.

The control device 11 determines whether or not to continue support as follows.

The acceleration in the vehicle width direction DX may intermittently continue in some cases. For example, when the curve is continuous, the acceleration in the vehicle width direction DX becomes “0” in the section in which the vehicle turns from the left to the right. However, in a case where the acceleration intermittently continues as described above, intermittently executing support according to a change in acceleration may be uncomfortable to the occupant. For this reason, stop of support may not be performed in the case where the acceleration intermittently continues.

Thus, the control device 11 determines whether or not a change in the predicted acceleration G is intermittent as follows. The control device 11 calculates the predicted acceleration G in the vehicle width direction DX to be applied to the vehicle after the lapse of a long-term set time longer than the set time from the present time. Then, the control device 11 determines whether or not to change the support amount S determined at the present time based on the predicted acceleration G after the lapse of the long-term set time. For example, in a case where the support amount S determined at the present time is determined to be “0,” when the predicted acceleration G after the lapse of the long-term set time is greater than the above-mentioned start reference value, the control device 11 does not update the support amount S to “0” and maintains the value of the support amount S determined before the present time.

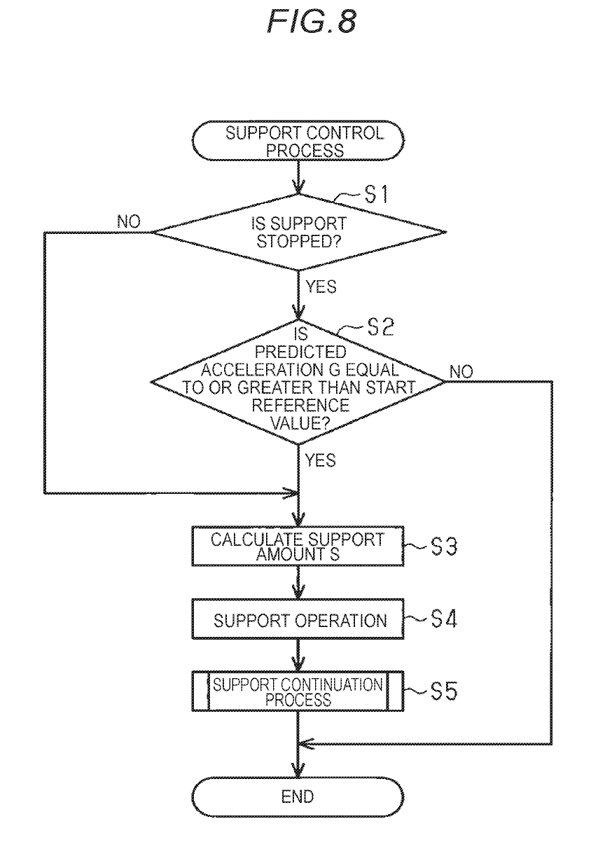

An example of “support control process” executed by the control device 11 of the support apparatus 10 will be described with reference to FIG. 8. The control device 11 determines the support amount S and operates the press device 12 by executing the support control process. Specifically, in the support control process, the vehicle speed V, the vehicle position PM, and the heading direction of the vehicle are used.

The control device 11 periodically executes the “support control process.” In the following description, “terminating the support control process” indicates a state where the control device 11 completes a series of steps of the “support control process” and stands by execution of the “support control process” of a next cycle.

In step S1, the control device 11 determines whether support is being executed or stopped. In addition, this determination is performed based on an instruction to the press device 12 issued by the control device 11. When support is not stopped (i.e., support is being executed, NO determination), step S3 to be described later is executed. When support is stopped, the process proceeds to step S2.

In step S2, the control device 11 determines whether or not the predicted acceleration G after the lapse of the set time is equal to or greater than the start reference value. When it is determined that the predicted acceleration G is less than the start reference value, the control device 11 terminates the support control process. When it is determined that the predicted acceleration G is equal to or greater than the start reference value, the control device 11 calculates the support amount S in step S3, and causes the press device 12 to perform an operation corresponding to the support amount S in step S4. Then, the control device 11 proceeds to step S5 to execute the following “support continuation process.” In the “support continuation process,” the control device 11 determines whether or not to continue support (i.e., whether or not to stop support).

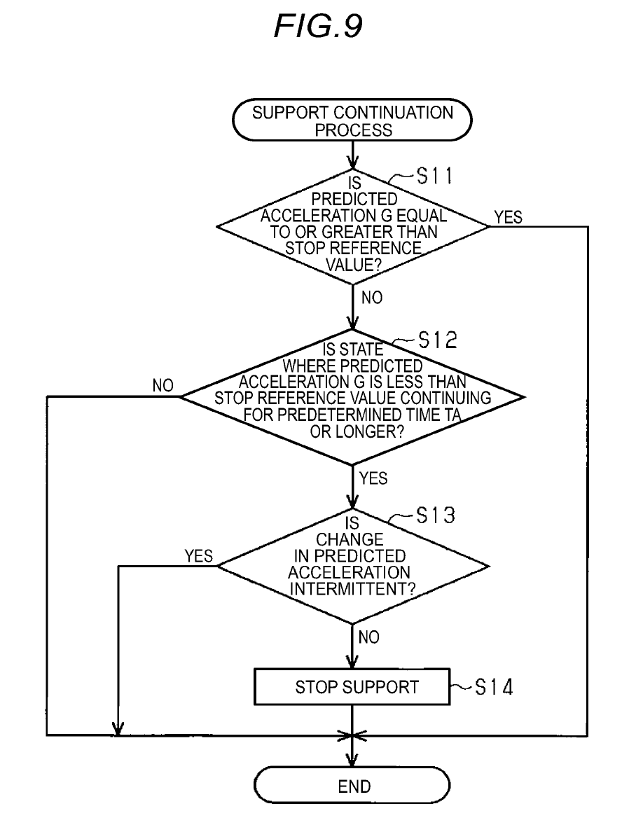

The “support continuation process” will be described with reference to FIG. 9.

In step S11, the control device 11 determines whether or not the predicted acceleration G is greater than or equal to the stop reference value. When it is determined that the predicted acceleration G is greater than or equal to the stop reference value, the control device 11 terminates the support continuation process and returns to the “support control process.” When the control device 11 determines that the predicted acceleration G is not equal to or greater than the stop reference value (is less than the stop reference value) (NO determination), the control device 11 executes step S12. In step S12, the control device 11 determines whether or not a state where the predicted acceleration G is less than the stop reference value continues for a predetermined time TA or longer. The predetermined time TA is a preset time and is 0.1 to several seconds. When this determination is denied (NO determination), i.e., when the predicted acceleration G is less than the stop reference value for the predetermined time (e.g., 1 second), the control device 11 terminates the “support continuation process,” and returns to the “support control process.” Therefore, support is continued.

In step S12, when the control device 11 determines that the state where the predicted acceleration G is less than the stop reference value continues for the predetermined time TA or longer (YES determination), the control device 11 executes step S13. In step S13, the control device 11 determines whether or not a change in the predicted acceleration G is intermittent. When the control device 11 determines that the change in the predicted acceleration G is intermittent (YES determination), the control device 11 terminates the “support continuation process” and returns to the “support control process.” Therefore, support is continued. When the control device 11 determines that the change in the predicted acceleration G is not intermittent, the control device 11 sets the support amount S to “0” in step S14, and stops support.

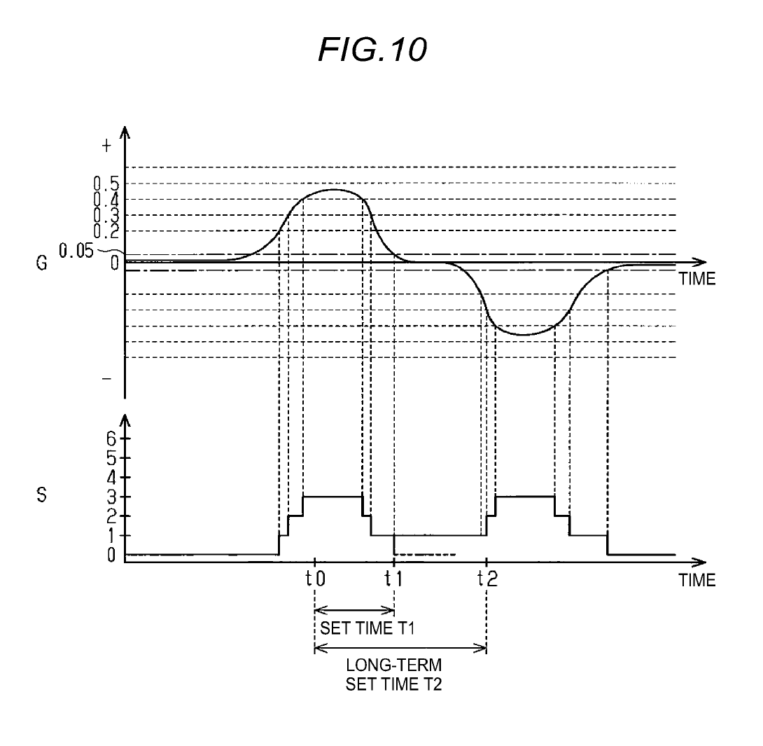

A change in the support amount S with respect to the predicted acceleration G will be described with reference to FIG. 10. The flowchart of FIG. 10 is an example of a chart created based on data recorded in real time when the vehicle travels on an S-shaped road. The chart illustrated in the upper part of FIG. 10 illustrates a change in the predicted acceleration G when the vehicle travels on the S-shaped road. The chart illustrated in the lower part of FIG. 10 illustrates a change in the support amount S determined based on the predicted acceleration G. The predicted acceleration G increases to the positive side and then decreases, and thus, becomes “0” on the way. Thereafter, the predicted acceleration G increases to the negative side, and then gradually decreases to “0.” Here, the positive side of the predicted acceleration G indicates the leftward direction of the vehicle width direction DX, and the negative side of the predicted acceleration G indicates the rightward direction of the vehicle width direction DX.

In principle, the support amount S is determined based on the increasing graph and the decreasing graph illustrated in FIGS. 4 and 5. Thus, the support amount S is set based on the magnitude of the predicted acceleration G. When the predicted acceleration G is positive, the chart illustrating the change in the support amount S substantially coincides with the chart of the predicted acceleration G. When the predicted acceleration G is negative, the chart illustrating the change in the support amount S substantially coincides with the chart obtained by inverting the chart of the predicted acceleration G upside down.

On the other hand, when the predicted acceleration G is “0,” the support amount S deviates from the value determined based on the increasing graph and the decreasing graph illustrated in FIGS. 4 and 5. This deviation is due to determination based on step S13 in the “support continuation process.” That is, such a deviation occurs based on the determination as to whether or not the change in the predicted acceleration G occurs intermittently. In FIG. 10, the two-dot dashed line illustrates the chart of the support amount S when determination based on step S13 is performed.

In this example, the control device 11 determines the support amount S to be “0” based on the predicted acceleration G at a time t1 after the lapse of the set time from the present time (time t0). However, since the predicted acceleration G is greater than the start reference value at a time t2 after the lapse of the long-term set time from the present time, the control device 11 does not change the support amount S to “0,” but maintains “1” which is the value determined before the time t1.

The action of the support apparatus 10 will be described.

As described above, the support apparatus 10 determines the support amount S based on the predicted acceleration G after the lapse of the set time from the present time. Therefore, the delay of support due to the time lag of the press device 12 is alleviated. In addition, the control device 11 changes the level of the support amount S based on an operation instruction from the operation unit 23. Therefore, the occupant may receive support suited to his/her preference. In addition, as described above, when the control device 11 predicts an intermittent change in the predicted acceleration G as described above, the support apparatus 10 restricts a change in support and suppresses discomfort of the occupant. As described above, according to the control device 11, it is possible to give the occupant appropriate support.

The effects of the support apparatus 10 will be described.

(1) The support apparatus 10 includes the press device 12 and the control device 11. The control device 11 changes the level of the support amount S based on an operation instruction. According to this configuration, since the level of the support amount S may be changed based on the intention of the occupant by an operation of the operation unit 23, it is possible to give the occupant support suitable for the occupant.

(2) The control device 11 determines the support amount S based on the pressing force to be applied to the occupant after the lapse of the set time from the present time.

According to this configuration, appropriate support (pressing force) to be applied to the occupant sometimes changes from moment to moment. Meanwhile, the press device 12 has a time lag from the time when it receives the instruction to the time when it completes an operation corresponding to the instruction. Thus, when controlling the press device 12 based on support (pressing force) to be applied to the occupant at the present time, the pressing force corresponding to the support amount S is applied to the occupant at the time delayed than the present time due to the time lag of the operation of the press device 12. Therefore, the pressing force having an inappropriate magnitude may be applied to the occupant. In this respect, according to the above configuration, the control device 11 determines the support amount S based on the pressing force to be applied to the occupant after the lapse of the set time from the present time. Therefore, the delay of support due to the time lag of the press device 12 is alleviated, and it is possible to give the occupant support of an appropriate magnitude.

(3) The control device 11 calculates the support amount S as a value corresponding to the predicted acceleration G in the vehicle width direction DX to be applied to the vehicle after the lapse of the set time from the present time. According to this configuration, when the predicted acceleration G in the vehicle width direction DX increases, it is possible to appropriately maintain the posture of the occupant.

(4) The control device 11 calculates the predicted acceleration G based on the vehicle speed V at the present time and the curvature Ri of the road at the position where the vehicle reaches after the lapse of the set time from the present time. According to this configuration, since the curvature Ri of the road is used, it is possible to accurately predict the predicted acceleration G. Therefore, it is possible to give the occupant appropriate support.

(5) The control device 11 determines whether or not to change the support amount S determined at the present time based on the magnitude of the predicted acceleration G in the vehicle width direction DX to be applied to the vehicle after the lapse of a long-term set time longer than the set time from the present time.

When the predicted acceleration G is intermittent, the support amount S is intermittent. Then, the occupant intermittently receives the pressing force. The intermittent pressing force may be uncomfortable to the occupant. In this respect, in the above configuration, it is determined whether or not to change, based on the magnitude of the predicted acceleration G after the lapse of the long-term set time, the support amount S determined based on the magnitude of the predicted acceleration G after the lapse of the set time from the present time. Therefore, a change in the support amount S decreases, and it is possible to reduce discomfort of the occupant.

### <Other Embodiments>

The support apparatus 10 is not limited to the example of the embodiment.

The press device 12 is not limited to the above structure. The press device 12 may be any device as long as it is capable of changing the pressing force for supporting the body of the occupant. For example, the press device 12 may be a device that opens and closes a supporter having an elastic member with an actuator.

In the above embodiment, the curvature Ri used when calculating the predicted acceleration G may be less than an average value of multiple positions. For example, the average value of the curvature Ri of the road at the vehicle position PMX that the vehicle reaches after the lapse of the set time and the curvatures Ri at the positions before and after this position may be set to the curvature Ri used when calculating the predicted acceleration G. Such an average value is regarded as “the curvature Ri of the road at the vehicle position PMX that the vehicle reaches after the lapse of the set time.”

In the above embodiment, the control device 11 calculates the support amount S to be applied to the occupant after the lapse of the set time from the present time, but may correct the support amount S calculated in this way based on other conditions. For example, at the present time, the support amount S may be increased based on the fact that the acceleration in the vehicle width direction DX is increasing. In addition, at the present time, the support amount S may be decreased based on the fact that the acceleration in the vehicle width direction DX is decreasing.

In the above embodiment, the support apparatus 10 may further have the following support function. For example, the support apparatus 10 tilts the seat back 1b when it is predicted that the vehicle tilts in the vertical direction after a lapse of a predetermined time from the present time. The control device 11 obtains the inclination of the vehicle from the road information of the navigation system 22. Then, the control device 11 controls a seat back drive device 30 (see the two-dot dashed line in FIG. 1) and changes the inclination of the seat back 1b in a direction opposite to the inclination of the road. For example, when the road is inclined upward, the seat back 1b is inclined forward. Therefore, it is possible to suppress the gaze of the occupant (e.g., the driver) from deviating from the road.

(1) A support apparatus according to an aspect of this disclosure supports an occupant sitting on a seat of a vehicle, and includes: a press device configured to support the occupant with a pressing force; and a control device configured to control the press device, in which the control device determines a support amount corresponding to a magnitude of the pressing force that presses the occupant, controls the press device so as to output the pressing force corresponding to the support amount, and changes a level of the support amount based on an operation instruction from an operation unit that is operated by the occupant. According to this configuration, since the level of the support amount may be changed based on the intention of the occupant by an operation of the operation unit, it is possible to give the occupant support suitable for the occupant.

(2) In the support apparatus, the control device may determine the support amount based on the pressing force to be applied to the occupant after a lapse of a set time from a present time. According to this configuration, the delay of support due to a time lag of the press device may be alleviated, and it is possible to give the occupant support having an appropriate magnitude.

(3) In the support apparatus, the control device may calculate the support amount as a value corresponding to a predicted acceleration in a vehicle width direction to be applied to the vehicle after the lapse of the set time from the present time. According to this configuration, when the predicted acceleration in the vehicle width direction increases, it is possible to appropriately maintain the posture of the occupant.

(4) In the support apparatus, the control device may calculate the predicted acceleration based on a vehicle speed at the present time and a curvature of a road at a position where the vehicle reaches after the lapse of the set time from the present time. According to this configuration, since the curvature of the road is used, it is possible to accurately predict the predicted acceleration in the vehicle width direction. Therefore, it is possible to give the occupant appropriate support.

(5) In the support apparatus, the control device may determine whether or not to change the support amount determined at the present time based on a magnitude of the predicted acceleration in the vehicle width direction to be applied to the vehicle after a lapse of a long-term set time longer than the set time from the present time.

When the predicted acceleration is intermittent, the support amount is intermittent. Then, the occupant intermittently receives the pressing force. The intermittent pressing force may be uncomfortable to the occupant. In this respect, in the above configuration, it is determined whether or not to change, based on the magnitude of the predicted acceleration after the lapse of the long-term set time, the support amount determined based on the magnitude of the predicted acceleration after the lapse of the set time from the present point. Therefore, a change in the support amount decreases, and it is possible to reduce discomfort of the occupant.

According to the support apparatus, it is possible to give an occupant support suitable for the occupant.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A support apparatus that supports an occupant sitting on a seat of a vehicle, the support apparatus comprising:
a press device configured to support the occupant with a pressing force; and
a control device configured to control the press device,
wherein the control device determines a support amount corresponding to a magnitude of the pressing force that presses the occupant, controls the press device so as to output the pressing force corresponding to the support amount, and changes a level of the support amount based on an operation instruction from an operation unit that is operated by the occupant.

2. The support apparatus according to claim 1,
wherein the control device determines the support amount based on the pressing force to be applied to the occupant after a lapse of a set time from a present time.

3. The support apparatus according to claim 1,
wherein the control device calculates the support amount as a value corresponding to a predicted acceleration in a vehicle width direction to be applied to the vehicle after the lapse of the set time from the present time.

4. The support apparatus according to claim 2,
wherein the control device calculates the support amount as a value corresponding to a predicted acceleration in a vehicle width direction to be applied to the vehicle after the lapse of the set time from the present time

5. The support apparatus according to claim 4,
wherein the control device calculates the predicted acceleration based on a vehicle speed at the present time and a curvature of a road at a position where the vehicle reaches after the lapse of the set time from the present time.

6. The support apparatus according to claim 2,
wherein the control device determines whether or not to change the support amount determined at the present time based on a magnitude of the predicted acceleration in the vehicle width direction to be applied to the vehicle after a lapse of a long-term set time longer than the set time from the present time.

7. The support apparatus according to claim 3,
wherein the control device determines whether or not to change the support amount determined at the present time based on a magnitude of the predicted acceleration in the vehicle width direction to be applied to the vehicle after a lapse of a long-term set time longer than the set time from the present time.

8. The support apparatus according to claim 4,
wherein the control device determines whether or not to change the support amount determined at the present time based on a magnitude of the predicted acceleration in the vehicle width direction to be applied to the vehicle after a lapse of a long-term set time longer than the set time from the present time.

9. The support apparatus according to claim 5,
wherein the control device determines whether or not to change the support amount determined at the present time based on a magnitude of the predicted acceleration in the vehicle width direction to be applied to the vehicle after a lapse of a long-term set time longer than the set time from the present time.
